(19) United States
(12) Patent Application Publication
(10) Pub. No.: US 2025/0126594 A1
(43) Pub. Date: Apr. 17, 2025

(54) WIRELESS DEVICE LOCATION DETERMINATION ASSISTED BY ONE OR MORE MOBILE VEHICLES

(71) Applicant: Telefonaktiebolaget LM Ericsson (publ), Stockholm (SE)

(72) Inventors: Jingya LI, GÖTEBORG (SE); Peter HAMMARBERG, MÖLNDAL (SE); Henrik SAHLIN, MÖLNLYCKE (SE); Yutao SUI, SOLNA (SE)

(73) Assignee: Telefonaktiebolaget LM Ericsson (publ), Stockholm (SE)

(21) Appl. No.: 18/688,692

(22) PCT Filed: Sep. 2, 2021
(86) PCT No.: PCT/EP2021/074212

§ 371 Date: Mar. 1, 2024

(51) Int. Cl. H04W 64/00

(52) U.S. Cl. CPC H04W 64/00

(57) ABSTRACT

A method performed in a wireless communication system for positioning a wireless device (140) connected to a respective operator network (110, 120, 160), assisted in part by a vehicle (101, 170, 190), the method comprising receiving a request for the vehicle (101, 170, 190) to approach the wireless device (140) associating the vehicle (101, 170, 190) with the operator network (110, 120, 160) triggering a network positioning procedure involving the wireless device (140) and the operator network (110, 120, 160), where the positioning procedure is at least based on communication of a positioning signal (171, 191) between the vehicle (101, 170, 190) and the wireless device (140), and on communication of respective positioning signals (111, 121) between one or more fixed access points (110, 120, 310) of the operator network and the wireless device (140), and determining a position of the wireless device (140) based on one or more measurements of the positioning signals (111, 121, 171, 191).

### TECHNICAL FIELD

The present disclosure relates to techniques for positioning a wireless device by means of a set of radio access points in a wireless access network assisted by a vehicle, such as an unmanned aerial vehicle (UAV), an unmanned ground vehicle (UGV), or some other mobile vehicle such as a first responder vehicle.

### BACKGROUND

An unmanned vehicle (UV), i.e., an unmanned aerial vehicle (UAV) or an unmanned ground vehicle (UGV), can be used to assist first responders in an emergency situation. For instance, if a person is in need of a defibrillator, a UV can in some case be used to deliver the defibrillator to the scene faster than would otherwise be possible by conventional means. A UAV in particular can also be used to deliver emergency supplies and medical equipment to areas which are difficult to access by the first responders, e.g., when a road is destroyed due to a natural disaster.

However, a potential problem is that the UV may not be able to locate the person who needs help with sufficient accuracy, and the person may not be in a condition to locate the vehicle, or guide the vehicle to the correct location. Currently, global positioning system (GPS) receivers or cellular network assisted positioning of a person is employed by the first responders. Such solutions often perform well in outdoor scenarios or in places where radio propagation from a plurality of radio base stations to a target wireless device is relatively unhindered. However, for indoor users, without careful deployment of radio nodes for positioning purposes (which can be costly and only available for very specific indoor scenarios like in automated industrial facilities), the current solutions can only provide a rough estimate of the area in which the person in need of help is located. Therefore, the UV may not be able to locate the person in need of assistance, or the location where the emergency supplies should be delivered, with sufficient accuracy. It is appreciated that a relatively small error may have dire consequences, such as if the supplies are delivered on the wrong side of some obstacle, like a wall or a chasm of some sort.

In U.S. Pat. No. 9,823,654 B2 a similar accuracy problem is solved by an unmanned aerial vehicle (UAV) which initially uses a navigation process that is based on a predetermined flight path configured to lead to an approximate target location that is associated with a medical emergency situation. For instance, when a bystander calls from their mobile phone to report a medical situation, the UAV or the medical-support system may determine the reported location of the mobile phone, and determine a number of waypoints between the UAV's location and the mobile phone's reported location. The UAV then navigates, via the predetermined waypoints, to the reported location. Since the reported location (which is the approximate target location, in this case), may not be exactly at the scene of the medical situation, navigation based on more accurate localization may be utilized to find and navigate to the specific location of the person within the stadium. Accordingly, when the UAV reaches the predetermined approximate target location, the UAV switches to a second navigation process based on the transmission of beacon signals, which then enables the UAV to more accurately locate and navigate to the exact scene of the medical situation.

Despite the advancements to-date, there is a need for further improvement in systems for assisting first responders in emergency situations.

### SUMMARY

It is an object of the present disclosure to provide improved systems for assisting first responders in emergency situations. This object is at least in part obtained by a method performed in a wireless communication system for positioning a wireless device connected to a respective operator network, assisted in part by a vehicle. The method comprises receiving a request for the vehicle to approach the wireless device, associating the vehicle with the operator network of the wireless device, and triggering a network positioning procedure involving the wireless device and the operator network, where the positioning procedure is at least partly based on communication of a positioning signal between the vehicle and the wireless device, and on communication of respective positioning signals between one or more fixed access points of the operator network and the wireless device. The method also comprises determining a position of the wireless device based on one or more measurements of the positioning signals.

This way, the vehicle or some other network entity is able to determine the position of the wireless device more accurately and robustly since there will be additional data available when solving the positioning problem. The positioning problem is solved by exploiting positioning functions already implemented in the operator network of the wireless device, which is an advantage. Further, the proposed methods can be used with legacy wireless devices, i.e., there is no need for prior updates to the wireless device before it can be positioned using the herein proposed methods.

The methods disclosed herein may further comprise navigating the vehicle towards the determined position of the wireless device. This means that the navigation process whereby the vehicle is guided towards the wireless device can be integrated with the positioning process, whereby a method for navigating the vehicle towards an accurately determined position of the wireless device is enabled.

The vehicle implementing the herein proposed methods can be any of an unmanned aerial vehicle (UAV), an unmanned ground vehicle (UGV), or a first responder vehicle. Notably, a plurality of vehicles of the same and/or different types can be used jointly to both position the wireless device as well as deliver emergency equipment o the location of the wireless device. For instance, a combination of a UAV and a UGV can be used, where the UAV may provide higher mobility and can gather more data relevant to the positioning problem, while the UGW may be able to provide a higher cargo transport capacity.

According to aspects, the vehicle comprises an electronic subscriber identity module (eSIM) or integrated access backhaul mobile termination (IAB-MT) functionality, arranged to facilitate associating the vehicle with the operator network. As will be discussed in more detail in the following, the vehicle may associate itself with the operator network of the wireless device in many different ways. However, the association process may be simplified if the vehicle carries an eSIM for identifying itself towards an enquiring network entity, or implements an IAB-MT functionality, which also facilitates the association of the vehicle with the operator network of the wireless device. The methods disclosed herein optionally also comprises pre-registering the vehicle with the operator network. This way, the association process may at least in part already be completed when the request for approaching the wireless device is received.

The method ma furthermore comprise obtaining an estimated coarse location associated with a position of the wireless device and navigating the vehicle to the coarse location prior to triggering the network positioning procedure. For instance, the operator network may already have some idea of where the wireless device is located. In this case, the vehicle can be roughly positioned before triggering the network positioning procedure.

The associating of the vehicle with the operator network of the wireless device optionally comprises emulating a radio base station of the operator network by the vehicle. Essentially, this means that the vehicle start to appear as a radio base station comprised in the operator network of the wireless device. Thus, the wireless device will become aware of its presence, and the participation of the vehicle in the operator network positioning procedure is thereby facilitated.

According to some aspects, the associating comprises executing an authorization procedure involving the vehicle and an authorization entity comprised in the operator network, resulting in a granted authorization or a refused authorization. This allows the operator network of the wireless device to have some control over which vehicles that are allowed to associate themselves with the operator network. This results in an increased level of integrity of the operator network. The authorization procedure may, for instance, comprise verification of a purpose of the authorization request, wherein the result of the authorization procedure depends on the purpose of the verification request. This allows an operator to select for which purposes a vehicle should be allowed to associate itself with the operator network. Again, this proves an increased control of the operator network. The granted authorization may for instance be valid for the duration of a pre-determined or specified time period and/or for some specified geographical area. The granted authorization may also be defined as valid within a specified network domain of the operator network.

According to other aspects, the network positioning procedure comprises determining a desired location of the vehicle, and navigating the vehicle to the desired location, prior to triggering at least a part of the network positioning procedure. This provides a further improvement of the positioning robustness and accuracy since the geometry of the positioning problem involving the wireless device and the fixed access points can be improved in this manner. For instance, the desired location of the vehicle can optionally be determined based on a relative geometry of the one or more fixed access points of the operator network and on an estimated location area of the wireless device. The desired location of the vehicle may also be determined based on a network operator input and/or based on position data from a database comprising previously determined desired locations.

According to some aspects, the positioning procedure comprises positioning the vehicle based on communication of a positioning signal between the vehicle and the one or more fixed access points of the operator network. Thus, the vehicle position need not be known a-priori in order to position the wireless device. The position of the vehicle can instead be determined jointly with the position of the wireless device.

According to some aspects, the method comprises establishing a direct radio link between the vehicle and the wireless device. This direct radio link may, e.g., be used for determining a distance between the wireless device and the vehicle, for instance using two-way ranging. This direct radio link range data may represent a valuable contribution to the solution of the positioning problem, which may improve the accuracy of the determined position by a considerable amount.

It is furthermore appreciated that the wireless device and/or the vehicle may optionally be arranged to determine an angle of arrival and/or an angle of departure of a received and/or transmitted positioning signal, respectively. In such cases, the network positioning procedure may comprise determining a bearing from the vehicle to the wireless device or vice versa, based on a positioning signal transmitted over the direct radio link between the vehicle and the wireless device. These measurements further improve the positioning accuracy. It is an advantage that modern cellular access network often implement antenna arrays enabling these types of measurements. For instance, if the operator network is a 5G 3GPP network, or a 6G 3GPP network, then there is a good chance that this capability is already implemented.

The methods disclosed herein may furthermore comprise executing a time synchronization procedure involving the vehicle and the operator network. As a result of this time synchronization procedure, unknown clock offsets and/or unknown clock skew or drifts can be reduced or even eliminated, which is an advantage.

The method may furthermore comprise configuring an operator network positioning signal to be transmitted or received by the vehicle during the positioning procedure. This means that the operator network can customize the positioning signal transmitted from the vehicle, in order to better comply with the existing positioning functions implemented in the operator network of the wireless device. The positioning signal may, for instance be a positioning reference signal (PRS) of a third 3GPP defined operator network.

The network positioning procedure may either be a downlink-based positioning procedure, an uplink-based positioning procedure, or a combination of a downlink and an uplink positioning procedure. The network positioning procedure may furthermore comprise transmission of any of a sounding reference signal (SRS), a random access signal transmitted over a physical random access channel (PRACH) and/or a demodulation reference signal (DMRS) of a 3GPP defined operator network.

The network positioning procedures discussed herein optionally comprises positioning the vehicle with respect to a coordinate system prior to triggering the network positioning procedure involving the operator network.

According to some aspects, determining the position of the wireless device based on one or more measurements comprises determining the position at least partly based on any of: time of flight of the positioning signal, angle of arrival of the positioning signal, angle of departure of the positioning signals, and a received signal power of the positioning signal. Also, determining the position of the wireless device based on the one or more measurements of the positioning signals may comprise aligning the network positioning procedure with a movement strategy of the vehicle, thereby further improving the positioning accuracy.

There is also disclosed herein vehicles, network nodes, authorization entities, computer programs, and computer program products associated with the above-mentioned advantages.

### BRIEF DESCRIPTION OF THE DRAWINGS

The present disclosure will now be described in more detail with reference to the appended drawings, where:

FIG. 1 shows aspects of an example communication system;

FIG. 2 illustrates an emergency response operation;

FIG. 3 illustrates positioning based on a time-difference-of-arrival technique;

FIG. 4 schematically illustrates nodes in a communication system;

FIG. 5 is a flow chart illustrating methods;

FIG. 6 illustrates two different example positioning geometries;

FIG. 7 schematically illustrates processing circuitry; and

FIG. 8 shows a computer program product.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

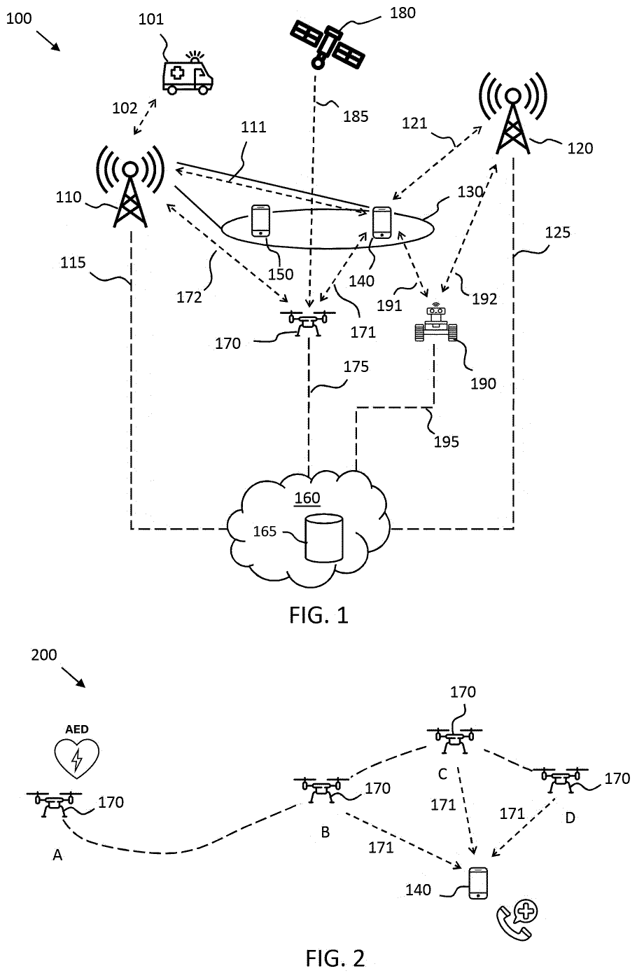

FIG. 1 illustrates an example communication system 100 where access points 110, 120 provide wireless network access to wireless devices 140, 150 over a coverage area 130. An access point in a fourth generation (4G) third generation partnership program (3GPP) network is normally referred to as an evolved node B (eNodeB), while an access point in a fifth generation (5G) 3GPP network is referred to as a next generation node B (gNodeB). The access points 110, 120 are connected 115, 125 to some type of core network 160, such as an evolved packet core network (EPC). The EPC is an example of a network which may comprise wired communication links, such as optical links. The core network may comprise one or more servers 165 and various network nodes, in a known manner. The fixed access points are usually deployed in fixed locations, and these locations are usually known by the network.

The wireless access network 100 supports at least one radio access technology (RAT) for communicating 111, 121 with wireless devices 140, 150, which at times are also referred to as user equipment (UE). It is appreciated that the present disclosure is not limited to any particular type of wireless access network type or standard, nor any particular RAT. The techniques disclosed herein are, however, particularly suitable for use with 3GPP defined wireless access networks, such as 4G, 5G and future 6G wireless access networks.

With reference to the discussion in the background section above, FIG. 1 illustrates a few examples of mobile vehicles 101, 170, 190 which can be used by first responders in an emergency situation, or in delivering some urgently required equipment to a target location. The vehicle may, for instance, be an unmanned aerial vehicle (UAV) 170, i.e., a drone, or an unmanned ground vehicle (UGV) 190. A first responder vehicle, such as an ambulance 101 or a police car also represents an example of a mobile vehicle in this context. These vehicles are arranged to be connected 102, 172, 192 to the access points 110, 120, and may also be arranged to form a direct radio link 171, 191 to one or more of the wireless devices 140, 150 in the wireless communication system 100. A radio link 185 to a satellite system 180 may also be implemented. This satellite link may comprise a positioning service, such as a GPS signal receiver, but may also comprise data transfer.

One or more of the vehicles 101, 170, 190 in FIG. 1 may wish to quickly locate one or more of the wireless devices 140, 150 in an emergency situation. For instance, a wireless device may have placed an emergency call to a first responder requesting urgent medical assistance. A wireless device may also be configured to send an emergency request communication in some other format to request urgent medical assistance, e.g., a tracking device worn by seniors which has detected a fall or the activation of an emergency button. A wireless device may also be used to indicate a location to where urgently required emergency supplies is to be delivered. It is desired to be able to robustly and accurately position the wireless device as part of the emergency response operation. It is a purpose of the present disclosure to facilitate such a robust and accurate positioning procedure.

FIG. 2 illustrates an example emergency operation 200 according to the present disclosure, here performed by a drone, which is an example of a UAV 170. The drone is initially located at position A and carries an automated external defibrillator (AED). An emergency call is placed, or emergency indication is sent, by a wireless device 140, requesting immediate delivery of the defibrillator equipment to the position of the wireless device. The proposed system then navigates the drone from position A to an area where the wireless device is believed to be located. This initial navigation may be performed based on rather coarse position information of the wireless device 140. Once the drone arrives in vicinity of the wireless device 140 the system associates the vehicle with the operator network of the wireless device. Of course, the association may also be done before the drone arrives in vicinity of the wireless device 140. According to a preferred embodiment, this means that the drone starts to emulate a radio base station of the operator network to which the wireless device is connected. The system then triggers a network positioning procedure involving the wireless device 140 and the operator network, where the positioning procedure is based on communication of a positioning signal 171 between the vehicle 170 and the wireless device 140, and on communication of respective positioning signals between one or more fixed access points or access points with known reference positions of the operator network and the wireless device 140. This way, the system is able to more accurately determine the position of the wireless device based on one or more measurements of the positioning signals. It is a particular advantage that the vehicle associates itself with the operator network of the wireless device since this allows for re-use of existing routines and procedures and does not require any new functionality to be implemented by the wireless device.

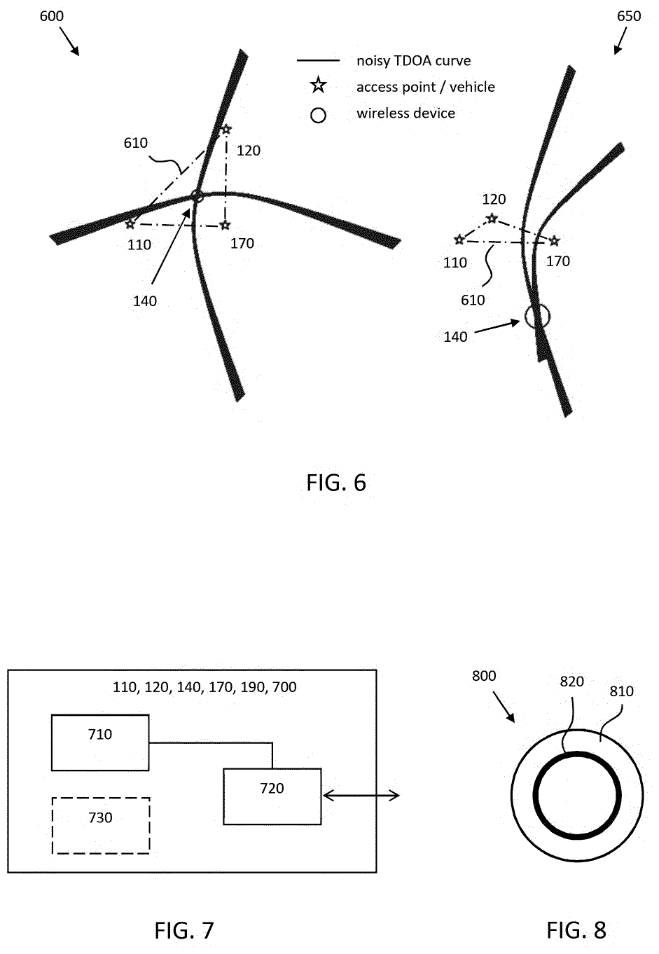

In the example of FIG. 2, the drone 170 performs three transmissions of positioning signals 171, from different locations B, C, D in vicinity of the wireless device 140. Each such transmission provides valuable input to the position estimation problem, and each such transmission is likely to improve the accuracy of the estimated wireless device position. Thus, the system is able to accurately pinpoint the position of the wireless device 140 and deliver the defibrillator in a reliable manner. Alternatively, the drone 170 can perform continuous or periodic transmission of the positioning signals after reaching a first desired location. This enables the wireless device to perform more measurements to improve the positioning accuracy. As will be discussed in more detail below, the system preferably synchronizes the transmissions of the positioning signals with the motion pattern of the mobile vehicle, such that the mobile vehicle is stationary or at least semi-stationary when communication of the positioning signals take place. Here, semi-stationary means that the communication of the positioning signals take place when the movement of the mobile vehicle is negligible and does not significantly affect the positioning accuracy. Also, the mobile vehicle is advantageously navigated to a desired location prior to triggering communication of the positioning signals. Such a desired location may, e.g., be associated with beneficial radio propagation conditions over a large area, or even tailored to provide a beneficial positioning problem geometry, as will be discussed below in connection to FIG. 6.

According to an example implemented in a 3GPP defined network setting, after arriving at the coarse location of a target wireless device 140, the vehicle emulates itself as a base station and sends a downlink positioning reference signal (PRS) to the wireless device. The wireless device can then measure the downlink PRS time difference of arrivals of several neighbor cells, including the regular base stations in the network and the base station emulated by the UAV, in comparison to a reference cell. In addition, if the operator network is a 5G network, antenna arrays are likely used. The network and/or the UAV can then also provide angular information when transmitting the PRS. The measurement results can be either sent to the UAV for calculation of the position of the user or the network can assist the UAV based on the measurements to find the user. The measurement data can also be forwarded to some positioning server arranged in the core network, which then performs the position estimation.

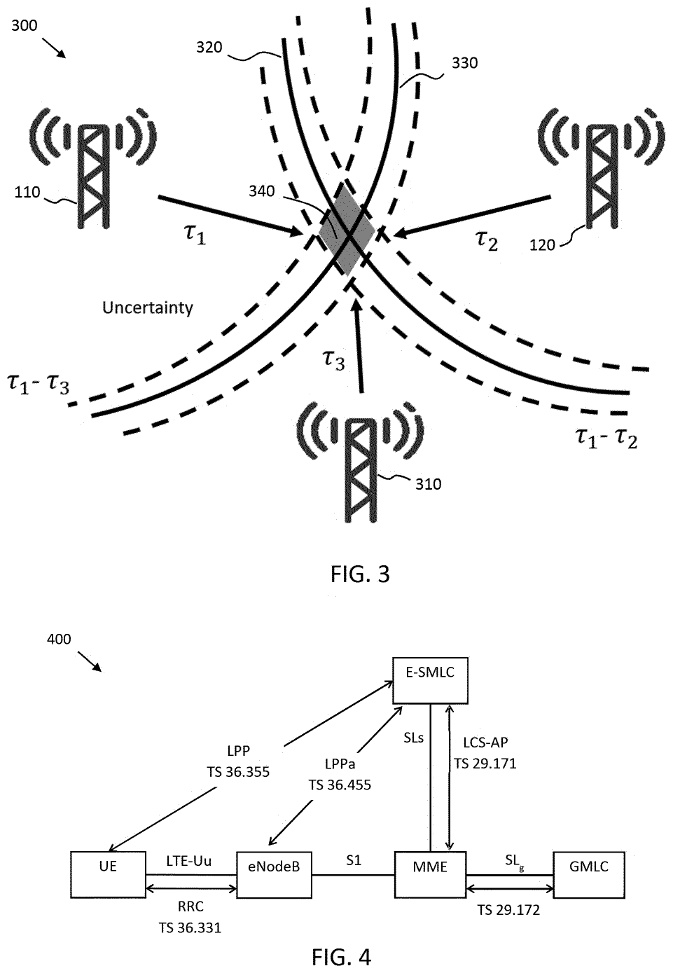

FIG. 3 shows an example 300 of a positioning technique using transmitted positioning signals. Observed Time Difference of Arrival (OTDOA) is a positioning feature introduced in release 9 of the E-UTRA (LTE radio). It's a positioning method in which a UE or wireless device measures the time difference between some specific signals sent from several eNodeBs, and reports these time differences to a specific device in the network (the Enhanced Serving Mobile Location Center E-SMLC). The E-SMLC then calculates the UE position based on the time differences and knowledge of the EnodeBs locations. The reason for using a TDOA approach to positioning is that there is an unknown clock offset between the synchronized base stations and the wireless device. Suppose that the unknown clock offset at a wireless device with respect to network time is Δ, and that the distance d between the wireless device located at coordinates y and an i:th base station located at coordinates xᵢ is d(y, xᵢ), then the time of arrival τᵢ associated with the i:th base station becomes

$${τ}_{i} = \frac{d ( y , {x}_{i} )}{c} + Δ$$

where c is the speed of light. Now, taking the difference between two such measurements made with respect to base stations i and j, given that the base stations are “sufficiently” synchronized, we have

$${τ}_{i} - {τ}_{j} = \frac{d ( y , {x}_{i} )}{c} - \frac{d ( y , {x}_{i} )}{c} + Δ - Δ = \frac{d ( y , {x}_{i} )}{c} - \frac{d ( y , {x}_{i} )}{c}$$

which no longer depends on the unknown clock offset.

FIG. 4 shows an overview 400 over a number of network nodes in a 3GPP network, together with the interfaces in between the nodes. This network architecture is generally known and will not be discussed in more detail herein. However, it is appreciated that the techniques proposed herein may leverage on a structure like this in order to improve the accuracy of an estimated position associated with a wireless device.

The vehicle is arranged to be associated with the operator network. For instance, it may have the ability to emulate a base station in one out of a plurality of operator networks, depending on which operator network that the wireless device is camping on. This means that the vehicle is equipped with required hardware and software to emulate itself as a base station, i.e., perform all or at least a subset of the procedures and actions which a fixed access point is configured to perform. After an emergency request is received, the vehicle should get an indication of the coarse location of the target wireless device. At the same time or during the process of approaching the target wireless device, the vehicle can further receive information of which operator's network should be used for the positioning purpose. In most of the cases, it should be the same operator that the wireless device belongs to. But in case of roaming or infrastructure sharing, a different operator's network may be used for the positioning service. After identifying the operator network that should be used during the positioning procedure, the vehicle will request to establish a secure connection with the operator's network 110, 120, 160. The vehicle and the operator's network then perform mutual authentication, e.g., either based on the existing procedures defined in 3GPP specification or a proprietary solution can be used. After being authorized to enter/associate with the operator's network, the vehicle may eventually emulate itself as a base station that belongs to the operator. That is, from the wireless device perspective, the vehicle appears as a regular base station with all the necessary signals broadcasted and the wireless device can camp on to it and set up connections with it. The vehicle can get configuration information from the operator, and use the configuration information to identify itself as a base station of the operator. From the operator's network perspective, the vehicle has to establish a secure connection with the operator network 110, 120, 160. The connection can also be established via, e.g. satellite connection.

With reference FIG. 3 and FIG. 3, an OTDOA procedure may work as follows: The E-SMLC requests through the LPP layer an OTDOA measurement, which is a set of Reference Signal Time Difference (RSTD) measurements from the UE. Together with this request the UE receives assistance data. This assistance data, provides a list of cells (enodeBs), with their PRS (Positioning Reference Signal) parameters, including bandwidth, periodicity etc. This is an example of a positioning signal, and the transmission of the signal here represents a communication of positioning signals.

The UE then proceeds to perform the measurements during a given period of time (typically up to 8 or 16 periods of the PRS signals). These measurements consist of estimating the exact time offsets between the PRS from different cells. Then it reports to the E-SMLC these estimated time differences together with an estimate of the measurement quality.

The E-SMLC then, using these time difference estimates, and the knowledge of the cells positions and transmit time offsets proceeds to estimate the position of the UE.

The description of the LPP (LTE positioning protocol) can be found in 3GPP TS 36.355, version 16.0.0, 2020 Jul. 24. The exact details of the PRS signals can be found in section 6.10.4 of the 3GPP TS 36.211 version 16.6.0, 2021 Jun. 30. A simple OTDOA procedure can be found in the RAN5 OTDOA testcases' descriptions in section 9 of 3GPP TS 37.571-1 version 16.9.0, 2021 Jul. 5.

From a UE architecture perspective the LPP layer resides outside of the EUTRAN protocol stack, over the non-access stratum (NAS), but typically implemented in the cellular modem firmware. The UE RSTD measurements themselves would be performed by the L1 layer.

In 5G, due to the use of much larger bandwidth compared to 4G and the use of beamforming techniques where a large number of antennas are used, the downlink positioning method may be further enhanced. For example, 3GPP has standardized power, angular and time measurement support for the PRS. A new entity, the location management function (LMF) is also introduced in 5G NR, which is central in the 5G positioning architecture. The LMF receives measurements and assistance information from the next generation radio access network (NG-RAN) and the mobile device, otherwise known as the user equipment (UE), via the access and mobility management function (AMF) over the NLs interface to compute the position of the UE. Due to the new next generation interface between the NG-RAN and the core network, a new NR positioning protocol A (NRPPa) protocol was introduced to carry the positioning information between NG-RAN and LMF over the next generation control plane interface (NG-C). These additions in the 5G architecture provide the framework for positioning in 5G. The LMF configures the UE using the LTE positioning protocol (LPP) via AMF. The NG RAN configures the UE using radio resource control (RRC) protocol over LTE-Uu and NR-Uu. Furthermore, due to the use of beamforming, the angular domain can also be used to further enhance the positioning accuracy. In 5G, the list of supported methods is extended to include round trip time (RTT) and angle-based positioning. The inclusion of new positioning methods and enhancements of existing positioning methods enables high accuracy positioning for several use cases in 5G.

In 5G, a service provider identifies a cell using an NCI (NR Cell Identity). This is a 36-bit identity which can be concatenated with the PLMN-Id (PLMN Identifier) to form the NCGI (NR Cell Global Identity). Cell Global Identity (CGI) is a globally unique identifier for a Base Transceiver Station in mobile phone networks. It consists of four parts: Mobile Country Code (MCC), Mobile Network Code (MNC), Location Area Code (LAC) and Cell Identification (CI). It is an integral part of 3GPP specifications for mobile networks, for example, for identifying individual base stations to “handover” ongoing phone calls between separately controlled base stations, or between different mobile technologies.

An Overview of Positioning in 5G New Radio is found in the paper by R. Keating, M. Säily, J. Hulkkonen and J. Karjalainen, “Overview of Positioning in 5G New Radio,” 2019 16th International Symposium on Wireless Communication Systems (ISWCS), 2019, pp. 320-324, doi: 10.1109/ISWCS.2019.8877160.

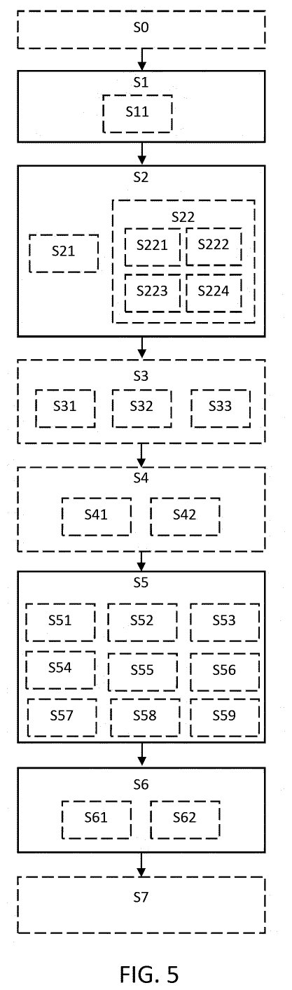

FIG. 5 is a flow chart which summarizes aspects of the herein proposed techniques. With reference also to FIG. 1, there is illustrated a method performed in a wireless communication system 100 for positioning a wireless device 140. The wireless device is connected to a respective operator network 110, 120, 160, and the positioning procedure is assisted in part by a vehicle 101, 170, 190, as illustrated in FIG. 1. The vehicle 101, 170, 190 may be any of an unmanned aerial vehicle (UAV) 170, an unmanned ground vehicle (UGV) 190, or a first responder vehicle such as a police car, a firefighting truck, or an ambulance.

The method comprises receiving S1 a request for the vehicle 101, 170, 190 to approach the wireless device 140. This request may, e.g., be triggered by an emergency call or an emergency request from the wireless device, or from some other network entity which desires to position the wireless device with increased accuracy or reliability for some reason. For instance, a network node such as an enhanced serving mobile location centre (E-SMLC) in a 3GPP defined communication system may determine that the current positioning accuracy for some particular wireless device is not sufficient for some application, such as guiding a first responder to the wireless device, and therefore generates the request. According to another example, the request may be triggered by a network node controlling the delivery of supplies or equipment to the location of the wireless device, such as a defibrillator or some other important object once it has entered a local area where the wireless device is located.

Known techniques, such as that disclosed in U.S. Pat. No. 9,823,654 B2, comprises activating transmissions of beacon signals when the vehicle enters a local area close to the wireless device. The beacon transmissions are then used to perform more fine-grained positioning to locate the wireless device, at least relative to the vehicle, with increased accuracy. This beacon transmission strategy may not always be effective, especially when the radio propagation conditions are complicated, and it does not make use of existing network infrastructure, nor of the positioning functions in place in many operator networks. The techniques disclosed herein leverage on existing infrastructure and software, both in the operator network and in the wireless device, to achieve accurate and robust wireless device positioning in an emergency situation. Furthermore, as operators have dedicated spectrum to operate their networks, better radio propagation conditions can be assumed comparing to services using unlicensed spectrum.

Thus, an alternative way to locate the wireless device with increased accuracy and/or reliability, different from that proposed in U.S. Pat. No. 9,823,654 B2, is to associate S2 the vehicle 101, 170, 190 with the operator network 110, 120, 160 of the wireless device, and then trigger S5 a network positioning procedure involving the wireless device 140 and the operator network 110, 120, 160, where the positioning procedure is at least partly based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140. This means that the vehicle is made part of the operator network, just like any other network node in the operator network, whereby network functions such as OTDOA positioning in an E-SMLC node is enabled, but now also involving the mobile vehicle. In other words, once the vehicle has been associated with the operator network, a positioning server or the like in the operator network can configure the vehicle to transmit and/or to receive network positioning signals and to take an active part in the network positioning operation according to standard procedures. According to a preferred implementation, the associating comprises emulating S21 a radio base station 310 of the operator network by the vehicle 101, 170, 190. Emulating S21 a radio base station means the vehicle is equipped with the necessary hardware and software that allows the vehicle to identify itself as an at least partially functional base station from the UE perspective. The vehicle can, e.g., form its own cell. This means that the vehicle may broadcast the necessary signals, e.g., synchronization signals, system information, etc, just like a regular base station. The vehicle is also allocated with a cell ID and allows wireless devices from a given operator which the vehicle is associated with to camp on and connect to the cell formed by the vehicle. From the network perspective, the vehicle is a functional base station that the network may configure with a desired configuration, e.g., allocating cell ID, bandwidth, broadcast certain signals for various purposes, etc, as a regular base station. Optionally, the network may also instruct certain wireless devices to perform measurements on the signals sent by the vehicle, and the network may also handover wireless devices to the cell operated by the vehicle. The vehicle may need to be authorized to perform certain functions by the network.

Herein, communication of respective positioning signals 111, 121 is to be construed broadly to encompass both transmission and reception of positioning signals. A communication of a positioning signal does not necessarily mean that any data carried by the positioning signal is successfully received by some node. Communication of a positioning signal may simply comprise the transmission of some waveform, followed by a measurement of received signal strength at some receiving network entity, like the wireless device or the vehicle, without any actual detection of data. Normally, however, communication of a positioning signal involves the transmission of electromagnetic radiation of some form from one network entity, followed by reception of the waveform at some other network entity, and the measurement of the positioning signal often involves some form of time of flight determination and/or angle of arrival/departure measurement if antenna arrays are used.

Based on the measurements of the positioning signals, it becomes possible to determine S6 the position of the wireless device 140 based on one or more measurements of the positioning signals 111, 121, 171, 191. Since the position is now determined also based on positioning signals transmitted and/or received from and/or to the mobile vehicle, the positioning accuracy likely increases, since there are more measurements available to base the position estimation on, and also since the geometry of the positioning problem is likely improved, as will be discussed in more detail below in connection to FIG. 6. According to different aspects of the disclosed method, determining the position of the wireless device 140 based on one or more measurements comprises determining S61 the position at least partly based on any of: time of flight of the positioning signal, angle of arrival of the positioning signal, angle of departure of the positioning signals, and a received signal power of the positioning signal.

It is appreciated that techniques discussed herein can be realized in a number of different ways, and the functionality can be distributed between any given number of network nodes. For instance, the actual determining of wireless device position from the measurements of the positioning signals, can be performed by the vehicle itself, by one or more of the access points, by the wireless device, or by a positioning server in the core network of the wireless communication system 100. The determining of position can also be performed in a distributed manner over more than one processing node. To realize the techniques discussed above, there is disclosed a vehicle 101, 170, 190 arranged to partake in positioning a wireless device 140 in a wireless communication system 100, wherein the wireless device 140 is arranged to be connected to a respective operator network 110, 120, 160. The vehicle 101, 170, 190 is arranged to receive a request from a network entity 165 to approach the wireless device 140, associate itself with the operator network 110, 120, 160, and to partake in a network positioning procedure involving the wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140.

There is also disclosed herein a network node 110, 120, 165 arranged to perform a network positioning procedure in a wireless communication system 100 for positioning a wireless device 140 connected to a respective operator network 110, 120, 160, assisted in part by a vehicle 101, 170, 190. The network node is arranged to receive a request for the vehicle 101, 170, 190 to approach the wireless device 140, associate the vehicle 101, 170, 190 with the operator network 110, 120, 160, trigger a network positioning procedure involving the wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140, and finally determine a position of the wireless device 140 based on measured time of flight of the positioning signals 111, 121, 171, 191.

Determining the position of the wireless device 140 based on the one or more measurements of the positioning signals 111, 121, 171, 191 may furthermore comprise aligning S62 the network positioning procedure with a movement strategy of the vehicle 101, 170, 190. For instance, the vehicle can be stopped and held stationary during transmission intervals of the positioning procedure. Obviously, if the vehicle moves unexpectedly during the positioning procedure, undesired positioning errors may be incurred. Alternatively, as the vehicle knows the direction it moves (there can be multiple sensors on the vehicle to measure this, e.g., by using camera and/or accelerometers), the measurements of positioning signals or the positioning results can be compensated for by the vehicle. A joint estimation of the positions of the vehicle and the wireless device is also possible by the network, e.g., based on a prior information of the vehicle and/or the wireless device. In this case, the network node may require the vehicle to send in additional information regarding is velocity or direction of the velocity changes. Notice that the network node often has a rough knowledge of the coarse position of the vehicle and the wireless device that needs to be positioned.

Some aspects of the herein disclosed methods also comprise navigating S7 the vehicle 101, 170, 190 towards the determined position of the wireless device 140. An example of this was discussed above in connection to FIG. 2, where a drone was used to deliver important equipment to the location of a wireless device having placed an emergency call. It is appreciated that the positioning procedure involving the wireless device, the access points and the vehicle may comprise repeated transmissions of positioning signals, and periodic updating of the wireless device position. Such repeated transmission of positioning signals is likely to improve the positioning accuracy further since more and more information about the location of the wireless device becomes available with every new communication of a positioning signal to and or from the wireless device.

It is appreciated that some example vehicles will have the ability to associate themselves with a plurality of different operator networks and select the network to associate with from the plurality of different operator networks in dependence of which operator network that the wireless device is currently connected to or camping on. Thus, depending on which network that the wireless device is connected to, the vehicle selects a network to associate itself with. Alternatively, some network node is aware of or determines the network of the wireless device, and then triggers the procedure for associating the vehicle with the correct operator network. According to some aspects, the vehicle 101, 170, 190 comprises an electronic subscriber identity module (eSIM) or integrated access backhaul mobile termination (IAB-MT) functionality, or some universal identity module arranged to facilitate associating the vehicle 101, 170, 190 with the operator network 110, 120, 160. In this way the vehicle can identify itself to different operators in a convenient manner and can be authorized to join different operator's network based on the operator serving the wireless device. Of course, the method may also comprise pre-registering S0 the vehicle 101, 170, 190 with the operator network. The vehicle can then be pre-registered with a plurality of operator networks, and the correct network association can just be activated on demand when needed to execute the method. This may potentially reduce latency involved in the network association procedure. The vehicle either communicates with the operator's network about is capability of emulating a base station, e.g., its transmitted power, supported bandwidth, number of antennas, etc. Or the operator's network may have stored the capability of the vehicle, e.g., associated with some kind of IDs of the vehicle. Based on the capability information, the operator's network configures the vehicle accordingly after the authentication and associates the vehicle with the operator network to emulate a base station based on some configurations.

The method may, as discussed above, also comprise obtaining an estimated coarse location associated with a position of the wireless device 140, and navigating S11 the vehicle 101, 170, 190 to the coarse location prior to triggering the network positioning procedure. The estimated coarse location may be a coverage area of an access point to which the wireless device is connected, or a course position obtained from, e.g., some form of satellite positioning system, like the GPS system. It is appreciated that the coarse location may be just a set of coordinates, or some area, such as a coordinate and an estimated radius which together defines an area with a circular boundary. This is an advantage since it may be inefficient to trigger the positioning procedure when the vehicle is too far from the wireless device. For instance, it does not make much sense to trigger the positioning procedure at a location where the wireless device is not within reach of a positioning signal transmitted from the vehicle.

It is appreciated that the operator network may be unwilling to let any vehicle be associated with it. Therefore, the method may advantageously comprise executing S22 an authorization procedure involving the vehicle 101, 170, 190 and an authorization entity comprised in the operator network, resulting in a granted authorization or a refused authorization. This authorization procedure may, e.g., comprise the vehicle making use of its eSIM or IAB-MT functionality in order to identify itself to the authorization entity in the operator network, and the authorization entity may then check the identity of the vehicle against a list of trusted vehicles which are allowed to associate themselves with the operator network. The authorization procedure itself may be based on a number of known authorization procedures, such as a challenge response procedure or the like. Such procedures are generally known and will therefore not be discussed in more detail herein. The authorization procedure may at least in part be performed by an authorization entity comprised in the wireless communication system 100.

Parts or all of the authorization procedure may be performed by an authorization entity, which is a network node 165 in the wireless communication system 100. The authorization entity 165 is arranged to execute an authorization procedure involving a vehicle 101, 170, 190, resulting in a granted authorization or a refused authorization, wherein, upon a granted authorization, the vehicle 101, 170, 190 is permitted to associate itself with the operator network 110, 120, 160, and to partake in a network positioning procedure involving a wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140.

The authorization procedure may for instance comprise verification S221 of a purpose of an authorization request, and the result of the authorization procedure can then depend on the purpose of the verification request. For instance, the vehicle may append a reason for its request to associate itself with the operator network, which reason may be associated with a degree of emergency. Some missions, such as delivery of non-critical good-to-have goods to some location may not be associated with a severe emergency, and may therefore be refused in case, e.g., the operator network is under heavy load. A request associated with severe emergency may still be granted even if the operator network is reluctant to let the vehicle associate itself with the network for some reason. Also, more than one mobile vehicle may accept the same mission, and the authorization entity is then in a position to select which of the vehicles that will be allowed to associate itself with the operator network and perform the mission.

The granted authorization may be configured such as to be valid for the duration of a pre-determined or specified time period S222. This way the integrity of the operator network is more easily maintained, since granted authorizations to associate a vehicle with the operator network will expire after some time. The granted authorization may also be configured such as to be valid within a specified geographical area S223 and/or a specified network domain of the operator network S224, which also advantageously improves network security and integrity.

It is understood that position accuracy to a large extent depends on the relative geometry of the participating entities, i.e., the wireless device, the access points, and the vehicle. Generally, as long as the target to be positioned is located within a convex hull of the reference points, i.e., the access points and the vehicle, then the achievable positioning accuracy tends to be rather good. However, as soon as the target node of the positioning problem goes outside of this convex hull, then the positioning performance quickly deteriorates. For at least this reason, the network positioning procedure optionally comprises determining S3 a desired location of the vehicle 101, 170, 190, and navigating the vehicle 101, 170, 190 to the desired location, prior to triggering at least a part of the network positioning procedure. This desired location may be a location associated with an advantageous geometry for positioning the wireless device with high accuracy. However, the desired location may simply be a location where sufficiently good radio propagation can be expected between a transceiver arranged on the vehicle and a transceiver of the wireless device.

The desired location of the vehicle 101, 170, 190 may for instance be determined S31 based on a relative geometry of the one or more fixed access points 110, 120, 310 of the operator network and on an estimated coarse location area of the wireless device 140. As an example, the desired location may be determined so as to encompass the wireless device within a convex hull defined by the positions of the access points and the vehicle. Of course, the desired location of the vehicle 101, 170, 190 may also be determined S32 based on a network operator input and/or based on position data from a database comprising previously determined desired locations.

FIG. 6 shows two different positioning geometries, both involving two fixed access points 110, 120, a vehicle 170, and a target wireless device 140 to be located. In the geometry 600 to the left in FIG. 6, the wireless device 140 is located inside the convex hull 610 (marked in dash-dotted line) formed by the positions of the access points 110, 120 and the vehicle 170. It is seen that the positioning accuracy is rather good in this case, due to the beneficial geometry of the positioning problem. However, if the wireless device 150 is instead outside of the convex hull 610, as illustrated on the right, then much larger positioning error is to be expected.

As discussed herein, various forms of measurements can be made on the transmitted positioning signals. One example is a time-of-arrival (TOA) measurement. A TOA measurement is normally asynchronous, since the transmitter and the receiver are not time-synchronized with each other, at least not accurately enough for positioning purposes. A common model for such a TOA measurement is a Gaussian noise model, i.e., the TOA measurement between a node i in the network to a node j in the network is modelled as

$${τ}_{i , j} = \frac{d ( {x}_{i} , {x}_{j} )}{c} + {Δ}_{i} - {Δ}_{j} + n$$

where d(xᵢ, xⱼ) is the actual distance in meters between node i at coordinates xᵢ to node j at coordinates xⱼ. The nodes have respective unknown clock offsets Δᵢ and Δⱼ, and the measurement is corrupted by Gaussian noise having some mean and variance.

Suppose that a number of time-of-arrival measurements, a vector T, are collected in the network 100, and that each time of arrival measurement can be modelled as a sum of one or more unknown clock offsets Δ and the distance d between the two transceivers measuring the time-of-arrival of the positioning signal. The distance d between two nodes in the network is of course a function of the coordinates x of the two transceivers. A vector t of such measurements can be modelled as a multi-variate Gaussian distribution

$$τ = {H}_{t} Δ + {H}_{d} d ( x ) + n$$

where Δ is a vector of unknown clock offsets, d (x) is a vector of inter-transceiver distances, Hₜ and H_{d} are matrices indicating which transceivers that are involved in each measurement, and n is multi-variate Gaussian noise. The measurement vector t then has a multi-variate Gaussian distribution with mean μ_{τ}(x,Δ) and some covariance V,

$$τ ∼ 𝒩 ( {μ}_{τ} ( x , Δ ) , V )$$

It is appreciated that there are many known methods to estimate the unknown parameters in a model like this, for instance based on a straight-forward least squares type of minimization:

$$[ \begin{matrix}\hat{x} \\ \hat{Δ}\end{matrix} ] = arg {min}_{x , Δ} \{ {[ τ - {μ}_{τ} ( x , Δ ) ]}^{T} {V}^{- 1} [ τ - {μ}_{τ} ( x , Δ ) ] \}$$

Thus, as long as a sufficient number of measurements are available in relation to the number of unknowns, joint estimation of coordinates and clock offsets in a wireless communication system 100 is possible. Interestingly, the positioning accuracy can also be inferred from a model like this. For instance, the Cramér-Rao lower bound on the covariance matrix can be easily derived as

$$Var ( [ \begin{matrix}\hat{x} \\ \hat{Δ}\end{matrix} ] ) \geq {[ [ \begin{matrix}{H}_{t}^{T} \\ {[ {H}_{d} {D}_{d} ]}^{T}\end{matrix} ] {V}^{- 1} \begin{matrix}[ {H}_{t} & {H}_{d} {D}_{d} ]\end{matrix} ]}^{- 1}$$

where D_{d} is the gradient of the distance vector d(x) taken with respect to the coordinates x.

This type of expression can be used to determine the expected positioning accuracy of positioning a node with unknown position given the known positions of the access points and the current estimated position of the vehicle. The information can of course also be used to determine a desired position of the vehicle for performing the positioning procedure. This means that the vehicle can first be navigated to a location which provides high accuracy positioning over an area in which the wireless device is believed to be located, after which the positioning procedure can be triggered, and the positioning signal communicated.

The access points 110, 120 are normally stationary transceivers with respective well-known positions in a global coordinate system. They are also normally synchronized to some common network clock. However, the vehicle is not stationary, and its position may not be perfectly known at all times. Also, the mobile vehicle may not be perfectly synchronized to the network clock. In order for the vehicle to be able to assist in the positioning procedure, its position needs to be determined in some manner. Either the position of the vehicle is determined explicitly, e.g., by initially positioning the vehicle using a GPS system or by triggering a network positioning procedure which uses the access points to position the vehicle, or implicitly by performing a joint estimation of both wireless device position and the position of the vehicle in relation to the access points with known location. For instance, the position of the vehicle and the position of the wireless device can be determined jointly based on least squares minimization as discussed above or using some other known method for joint positioning of two or more nodes in a network. Consequently, the positioning procedure optionally comprises positioning S33 the vehicle 101, 170, 190 based on communication of a positioning signal 172 between the vehicle 101, 170, 190 and the one or more fixed access points 110, 120, 310 of the operator network. This positioning procedure for positioning the vehicle may be performed separately from the positioning procedure aimed at positioning the wireless device, or jointly in the same positioning procedure, i.e., a joint estimation of the position of the vehicle and the position of the wireless device at the same time. Thus, according to aspects, the network positioning procedure comprises jointly positioning S59 the vehicle 101, 170, 190 and the wireless device 140.

According to related aspects of the method, the network positioning procedure comprises positioning S58 the vehicle 101, 170, 190 with respect to a coordinate system prior to triggering the network positioning procedure involving the operator network. This coordinate system may be a global coordinate system, or a coordinate system defined using one of the access points are reference, or even using the wireless device as reference.

Further increases in the positioning performance may be obtained by establishing S4 a direct radio link between the vehicle 101, 170, 190 and the wireless device 140. This direct radio link can be used to obtain distance information and/or a bearing indicating a geometrical relationship between the wireless device and the vehicle. For instance, the direct radio link can be used to estimate a distance between the wireless device and the vehicle, which estimate of distance may provide valuable information in the overall positioning procedure. In other words, the network positioning procedure comprises determining S41 a distance between the vehicle 101, 170, 190 and the wireless device 140 based on a positioning signal transmitted over the direct radio link between the vehicle 101, 170, 190 and the wireless device 140. Methods for estimating distance based on communication of a positioning signal over a radio link are generally known and will therefore not be discussed in more detail herein. The wireless device 140 and/or the vehicle 101, 170, 190 may also be arranged to determine an angle of arrival and/or an angle of departure of a received and/or transmitted positioning signal, respectively. In this case the network positioning procedure may comprises determining S42 a bearing from the vehicle 101, 170, 190 to the wireless device 140 or vice versa, based on a positioning signal transmitted over the direct radio link between the vehicle 101, 170, 190 and the wireless device 140.

In order for the vehicle to successfully take part in a network positioning procedure involving the access points and the wireless device, it may be advantageous to execute S51 a time synchronization procedure involving the vehicle 101, 170, 190 and the operator network. This time synchronization procedure targets incorporating the vehicle into the same time base as used by the access points.

The method may furthermore comprise configuring S52 an operator network positioning signal to be transmitted or received by the vehicle 101, 170, 190 during the positioning procedure. The operator network positioning signal may vary from operator to operator. However, in a 3GPP-defined radio access network, such as a 4G or a 5G network, the positioning signal will normally be a positioning reference signal (PRS) S53. The description of the LTE positioning protocol (LPP) can be found in 3GPP TS 36.355 version 16.0.0, 2020 Jul. 24. The exact details of the PRS signals can be found in section 6.10.4 of 3GPP TS 36.211 version 16.6.0, 2021 Jun. 30. An example OTDOA procedure can be found in the RAN5 OTDOA testcases' descriptions in section 9 of 3GPP TS 37.571-1 version 16.9.0, 2021 Jul. 5.

The network positioning procedure may generally comprise any of a downlink (DL) network positioning procedure S54 and/or an uplink (UL) network positioning procedure S56. The network positioning procedure may comprise transmission of any of a sounding reference signal, SRS, a random access signal transmitted over a physical random access channel, PRACH, and/or a demodulation reference signal, DMRS of a third generation partnership, 3GPP, defined operator network S55. The network positioning procedure may, as discussed above at least in part be based on a time-difference-of-arrival (TDOA) technique S57.

A non-limiting example of the proposed method will now be given. The example is based on DL communication, and the wireless device position is determined based on OTDOA measurements as discussed above. The UV is either equipped with eSIM or IAB-MT functionality, or some universal identity module. In this way, the UV can identify itself for different operators and can be authorized to join different operator's network based on the operator serving the target UE that requests the emergency service. This example does not limit the functions of the described apparatus. A skilled person should understand that certain functionalities may be performed by various nodes, e.g., the positioning can be either performed at a service, a base station, at the UV, or being implemented in a disturbed manner.

Step 1, The UV needs to be in contact with the operator which the target user's mobile device belongs to. This is important, as only the operator's positioning server can instruct the UE to perform OTDOA based positioning. Certainly, several operators can share the same positioning server, but it is only from the cell the target UE connects to, it can receive the positioning request from the network. This essentially means that the UV must associate itself to the operator network in some way. For security and privacy reasons, the operator may need to authorize the UV to access the user location related information and other services that may be needed for the UV to determine the accurate location of the user.

Step 2, upon receiving the request from the UV, the operator has to decide whether to authorize the UV to use its network and/or positioning server to position the target UE. The operator may choose to verify the purpose of the request, i.e., whether it is based on an emergency situation. Optionally, the operator can determine a time period, in which the UV can access its network. The UV is then registered with the operator and/or positioning server or any other servers with the same functionality) in the operator's network.

Step 3, with the authorization of the operator, the UV may emulate itself as a base station of the operator which the target UE belongs to. The UV then join the operator's network and become a part of the network (e.g., emulating itself as a functional base station). Either the operator may determine the cell ID, SI and other related information for the UV to become a functional base station, i.e., it can be detected by a UE and the UE may camp on it properly, or the UV can decide to use a pre-determined setup to emulate itself as a base station. Notice, this step is needed, as cellular DL based positioning method, e.g., OTDOA based positioning, at least a cell ID is needed for the UE to perform the RSTD measurement.

Step 4, as the UV approaches the coarse location where the target UE is located, the UV begins to transmit the necessary signals i.e., PRS and other signals e.g., synchronization signal, MIB, SIB. Therefore, it can be identified by the UE in the later cellular DL based positioning method, e.g., OTDOA based positioning. The UV may also transmit the PRS signal according to the configurations received from the operator. In this step, the coarse location may be determined, e.g., based on the severing cell of the target UE, e.g., the cell the UE has a connection with or camped on. That is when the UV enters a cell e.g., the UV can detect Cell ID), it begins to transmit the necessary signal. Alternatively, as the UV is a moving beacon which moves towards to the UE, in order to reduce the interference and/or save power and/or improve positioning accuracy which assists the UV to avoid flying longer route than necessary, the UV can obtain a desired position, and when reaching the neighborhood of the desired position, the UV begins to transmit the necessary signals. The desired position or neighborhood of the desired position may be based on e.g., computing, the Cramer-Rao bound for position estimation in terms of variance or co-variance of the target UE. For exampling by using one or more of the existing positioning information, e.g., Cell IDs that the target UEs observes, the PRS measurement results of the target UE from base stations and/or GPS information and/or other GNSS system that the target UE provides to the positioning server, e.g., the positioning server in the network can estate a favorite position for the UV, at which it reaches the lower or upper bound of the positioning accuracy of the target UE e.g., the minim variance is reached and the accuracy cannot be further improved). This means the UV is guided by the NW to a place which the NW may have use its best effort to position the target UE, then the UV is on its own to reach the target UE. The UV then begins to transmit the necessary signals to locate the target UE. The favorite position is obtained from a NW work node by the UV but alternatively, the NW can communicate fully or partially the collected information to the UV Cell IDs that the target UEs observes, the PRS measurement results of the target UE from base stations and/or GPS information and/or other GNSS system that the target UE provides to the positioning server), and UV can estimate fully or partially fine tune) itself about the favor position.

Step 5, the network operator determines which base stations are needed in order to position the target UE. For example, which base stations are in the neighborhood of the UE. Then the operator checks whether there are PRS configurations for these base stations. If the base stations have no PRS configurations, the operator can provide one. The operator then can instruct the identified base station(s) to transmit PRS accordingly.

Step 6, the network operator determines the PRS configuration used by the UV. If there is no PRS configuration, the operator can provide one. Then the operator then can instruct the UV to transmit PRS accordingly or the UV can determine whether to transmit the PRS based on its current situation, e.g., whether it is close enough to the target UE.

Step 7, the positioning server at the operator, instructs the target UE to perform cellular DL based positioning method, e.g., OTDOA based positioning RSTD measurements based on the PRS configurations. The network will send cellular DL based positioning method, e.g., OTDOA based positioning, Assistance Data to the UE for the UE to perform cellular DL based positioning method, e.g., OTDOA based positioning RSTD measurements. What is included in the cellular DL based positioning method, e.g., OTDOA based positioning, Assistance Data can be found in [4] and references therein. In this step, either the current cell the UE camp on is set to as the reference cell or the UV can be set as the reference cell if the UV can be identified by the UE.

At the same time, the positioning server may request the UV to report its current location. The UV can position itself based on GPS and/or using network-based positioning measure, e.g., cellular DL based positioning method, e.g., OTDOA based positioning and/or using some other method to determine its position. This is very important, as the UV is a moving object whose position changes in real time. Therefore, an accurate estimation of the UV position reduces the error for the determining of the position of the UE. Furthermore, as the UV is moving, it may introduce extra errors when the UE performs the measurement. In order to minimize the error caused by the moving UV, a measurement period that is aligned with the movement strategy of the UV. E.g., UV is kept static in a certain time duration before moving to another place. Alternatively, the UV or the positioning server can take the movement of the UV into account when calculating the UE position relative to the UV. For example, the UV or the network understands where the location of the UV is when the UE performs the measurements, and then comparing to its new location during the movement and calculate the position of the UE. Operationally, a common reference cell should be determined by the network, and both the UE and the UV should be informed about this common reference cell. Alternatively, a joint estimation approach may be used. That is based on joint estimation, e.g., based on the current position estimates of the UV and UE and accuracy position estimates of the UV and UE e.g., variance estimation and/or co-variance of the positioning estimation), the NW may estimate a direction for the UV to move that minimize the errors or variance of the estimated distance between the UV and the UE.

Notice the goal of step 7 is to provide necessary information and measurements in order for the UV to determine the position of the UE. It is important to understand that the UV is a moving object whose position changes in real time. Therefore, alternatively, it may be beneficial that the UV does the calculation itself based on the measurement results provide by the UE due to the network commination delays. Hence, alternatively, instead of letting the positioning server to calculate the positions of both the UV and the UE, the positioning server may also directly forward the measurement results of the UE to the UV, and then the UE can directly calculate the UE position. If there is a chance the UV is in the approximate of the UE, and the UE can camp on or connect to or being handed over to the UV, then the UE can also directly send the measurements to the UV for the UV to calculate the position of the UE. Alternatively, the UE can use sidelink interfaces to establish communication with the UV, and send the measurements results and/or other location related information to the UV for the UV to estimate the position of the UE.

Step 8, the UV reports to the NW mission complete, and detach itself from the network and stop emulating itself as a base station.

FIG. 7 schematically illustrates, in terms of a number of functional units, the general components of a network node 110, 120, 140, 170, 190, 700 according to embodiments of the discussions herein. Processing circuitry 710 is provided using any combination of one or more of a suitable central processing unit CPU, multiprocessor, microcontroller, digital signal processor DSP, etc., capable of executing software instructions stored in a computer program product, e.g., in the form of a storage medium 730. The processing circuitry 710 may further be provided as at least one application specific integrated circuit ASIC, or field programmable gate array FPGA.

Particularly, the processing circuitry 710 is configured to cause the device 110, 120, 140, 170, 190, 700 to perform a set of operations, or steps, such as the methods discussed in connection to FIG. 4 and the discussions above. For example, the storage medium 730 may store the set of operations, and the processing circuitry 710 may be configured to retrieve the set of operations from the storage medium 730 to cause the device to perform the set of operations. The set of operations may be provided as a set of executable instructions. Thus, the processing circuitry 710 is thereby arranged to execute methods as herein disclosed. In other words, there is shown a network node 110, 120, 140, 170, 190, 700 comprising processing circuitry 710, a network interface 720 coupled to the processing circuitry 710 and a memory 730 coupled to the processing circuitry 710, wherein the memory comprises machine readable computer program instructions that, when executed by the processing circuitry, causes the network node to transmit and to receive a radio frequency waveform.

The storage medium 730 may also comprise persistent storage, which, for example, can be any single one or combination of magnetic memory, optical memory, solid state memory or even remotely mounted memory.

The device 110, 120, 140, 170, 190, 700 may further comprise an interface 720 for communications with at least one external device. As such the interface 720 may comprise one or more transmitters and receivers, comprising analogue and digital components and a suitable number of ports for wireline or wireless communication.

The processing circuitry 710 controls the general operation of the device 110, 120, 140, 170, 190, e.g., by sending data and control signals to the interface 720 and the storage medium 730, by receiving data and reports from the interface 720, and by retrieving data and instructions from the storage medium 730. Other components, as well as the related functionality, of the control node are omitted in order not to obscure the concepts presented herein.

FIG. 8 illustrates a computer readable medium 810 carrying a computer program comprising program code means 820 for performing the methods illustrated in, e.g., FIG. 5, when said program product is run on a computer. The computer readable medium and the code means may together form a computer program product 800.

The techniques and methods discussed above, in particular in connection to FIG. 5, can be realized in a number of different ways, and the functionality can be distributed between any given number of network nodes. For instance, the actual determining of wireless device position from the measurements of the positioning signals, can be performed by the vehicle, by one or more of the access points, or by a positioning server such as the E-SMLC. The determining of position can also be performed in a distributed manner over more than one processing node.

To realize the techniques discussed above, there is disclosed a vehicle 101, 170, 190 arranged to partake in positioning a wireless device 140 in a wireless communication system 100, wherein the wireless device 140 is arranged to be connected to a respective operator network 110, 120, 160, wherein the vehicle 101, 170, 190 is arranged to:
receive a request from a network entity 165 to approach the wireless device 140,
associate itself with the operator network 110, 120, 160, and to
partake in a network positioning procedure involving the wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140.

According to aspects, the vehicle 101, 170, 190 is any of an unmanned aerial vehicle, UAV, 170, an unmanned ground vehicle, UGV, 190 or a first responder vehicle.

According to aspects, the vehicle is arranged to determine a position of the wireless device 140 based on one or more measurements of the positioning signals 111, 121, 171, 191.

According to aspects, the vehicle 101, 170, 190 comprises an electronic subscriber identity module, eSIM, or integrated access backhaul mobile termination, IAB-MT, functionality, arranged to facilitate associating the vehicle 101, 170, 190 with the operator network 110, 120, 160.

According to aspects, the vehicle 101, 170, 190 is arranged to obtain an estimated coarse location associated with a position of the wireless device 140, and to navigate to the coarse location prior to partaking in the network positioning procedure.

According to aspects, the vehicle is arranged to emulate a radio base station 310 of the operator network.

According to aspects, the vehicle is arranged to execute an authorization procedure involving the vehicle 101, 170, 190 and an authorization entity comprised in the operator network, resulting in a granted authorization or a refused authorization

According to aspects, the vehicle is arranged to establish a direct radio link between itself and the wireless device 140.

According to aspects, the vehicle 101, 170, 190 is arranged to determine a distance between the vehicle 101, 170, 190 and the wireless device 140 based on a positioning signal transmitted over the direct radio link between the vehicle 101, 170, 190 and the wireless device 140.

According to aspects, the vehicle 101, 170, 190 is arranged to obtain one or more measurements of the positioning signals 171, 191, and to forward the measurements to a positioning server comprised in the operator network.

There is also disclosed herein a network node 110, 120, 165 arranged to perform a network positioning procedure in a wireless communication system 100 for positioning a wireless device 140 connected to a respective operator network 110, 120, 160, assisted in part by a vehicle 101, 170, 190, wherein the network node is arranged to
receive a request for the vehicle 101, 170, 190 to approach the wireless device 140,
associate the vehicle 101, 170, 190 with the operator network 110, 120, 160,
trigger a network positioning procedure involving the wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140, and
determine a position of the wireless device 140 based on measured time of flight of the positioning signals 111, 121, 171, 191.

According to aspects, the network node 110, 120, 165 is arranged to configure respective positioning signals by the vehicle 101, 170, 190 and by the one or more fixed access points 110, 120, 310 of the operator network.

According to aspects, the network node 110, 120, 165 is arranged to determine a position of the wireless device 140 based on one or more measurements of the positioning signals 111, 121, 171, 191.

According to aspects, the network node 110, 120, 165 is arranged to obtain one or more measurements of the positioning signals 171, 191, and to forward the measurements to a positioning server comprised in the operator network.

According to aspects, the network node 110, 120, 165 is arranged to instruct the wireless device 140 and/or the vehicle 101, 170, 190 to perform one or more measurements of the positioning signals 111, 121, 171, 191.

According to aspects, the network node 110, 120, 165 is arranged to navigate the vehicle 101, 170, 190 towards a determined position of the wireless device 140.

According to aspects, the network node 110, 120, 165 is arranged to obtain and to transmit an estimated coarse location associated with a position of the wireless device 140 to the vehicle 101, 170, 190, and to request navigation by the vehicle to the coarse location prior to triggering the network positioning procedure.

According to aspects, the network node 110, 120, 165 is arranged to execute an authorization procedure involving the vehicle 101, 170, 190, resulting in a granted authorization or a refused authorization.

According to aspects, the network node 110, 120, 165 is arranged to allow the vehicle to emulate a radio base station 310 of the operator network in case of a granted authorization.

According to aspects, the network node 110, 120, 165 is arranged to determine a desired location of the vehicle 101, 170, 190 for performing at least part of the network positioning procedure.

According to aspects, the network node 110, 120, 165 is arranged to determine the desired location of the vehicle 101, 170, 190 at least partly based on a relative geometry of the one or more fixed access points 110, 120, 310 of the operator network and on an estimated location area of the wireless device 140.

According to aspects, the network node 110, 120, 165 is arranged to determine the desired location of the vehicle 101, 170, 190 at least partly based on a network operator input and/or based on position data from a database comprising previously determined desired locations.

There is furthermore disclosed herein an authorization entity 165 in a wireless communication system 100, comprised in an operator network,
wherein the authorization entity 165 is arranged to execute an authorization procedure involving a vehicle 101, 170, 190, resulting in a granted authorization or a refused authorization,
wherein, upon a granted authorization, the vehicle 101, 170, 190 is permitted to associate itself with the operator network 110, 120, 160, and to partake in a network positioning procedure involving a wireless device 140 and the operator network 110, 120, 160, where the positioning procedure is based on communication of a positioning signal 171, 191 between the vehicle 101, 170, 190 and the wireless device 140, and on communication of respective positioning signals 111, 121 between one or more fixed access points 110, 120, 310 of the operator network and the wireless device 140.

According to aspects, the vehicle 101, 170, 190 comprises an electronic subscriber identity module, eSIM, or integrated access backhaul mobile termination, IAB-MT, functionality, arranged to facilitate associating the vehicle 101, 170, 190 with the operator network 110, 120, 160.

According to aspects, the authorization procedure comprises verification of a purpose of an authorization request, wherein the result of the authorization procedure depends on the purpose of the verification request.

According to aspects, the granted authorization is valid for the duration of a pre-determined or specified time period.

According to aspects, the granted authorization is valid within a specified geographical area.

According to aspects, the granted authorization is valid within a specified network domain of the operator network.

1. A method performed in a wireless communication system for positioning a wireless device connected to a respective operator network, assisted in part by a vehicle, the method comprising
receiving a request for the vehicle to approach the wireless device,
associating the vehicle with the operator network of the wireless device,
triggering a network positioning procedure involving the wireless device and the operator network, where the positioning procedure is at least partly based on communication of a positioning signal between the vehicle and the wireless device, and on communication of respective positioning signals between one or more fixed access points of the operator network and the wireless device, and
determining a position of the wireless device based on one or more measurements of the positioning signals.

2. The method of claim 1, further comprising navigating the vehicle towards the determined position of the wireless device.

3. (canceled)

4. The method of claim 1, wherein the vehicle comprises an electronic subscriber identity module, eSIM, or integrated access backhaul mobile termination, IAB-MT, functionality, arranged to facilitate associating the vehicle with the operator network.

5. (canceled)

6. The method of claim 1, comprising obtaining an estimated coarse location associated with a position of the wireless device, and navigating the vehicle to the coarse location prior to triggering the network positioning procedure.

7. The method of claim 1, wherein the associating comprises emulating a radio base station of the operator network by the vehicle.

8. The method of claim 1, wherein the associating comprises executing an authorization procedure involving the vehicle and an authorization entity comprised in the operator network, resulting in a granted authorization or a refused authorization.

9. The method of claim 8, wherein the authorization procedure comprises verification of a purpose of an authorization request, wherein the result of the authorization procedure depends on the purpose of the verification request.

10. The method of claim 8, wherein
the granted authorization is valid for the duration of a pre-determined or specified time period,
the granted authorization is valid within a specified geographical area, and/or
the granted authorization is valid within a specified network domain of the operator network.

11-12. (canceled)

13. The method of claim 1, wherein the network positioning procedure comprises determining a desired location of the vehicle, and navigating the vehicle to the desired location, prior to triggering at least a part of the network positioning procedure.

14. The method of claim 13, wherein
the desired location of the vehicle is determined based on a relative geometry of the one or more fixed access points of the operator network and on an estimated location area of the wireless device, and/or
the desired location of the vehicle is determined based on a network operator input and/or based on position data from a database comprising previously determined desired locations.

15. (canceled)

16. The method of claim 1, where the positioning procedure comprises positioning the vehicle based on communication of a positioning signal between the vehicle and the one or more fixed access points of the operator network.

17. The method of claim 1, comprising establishing a direct radio link between the vehicle and the wireless device.

18. The method of claim 1, wherein the network positioning procedure comprises determining a distance between the vehicle and the wireless device based on a positioning signal transmitted over the direct radio link between the vehicle and the wireless device.

19. The method of claim 1, wherein the wireless device and/or the vehicle is arranged to determine an angle of arrival and/or an angle of departure of a received and/or transmitted positioning signal, respectively, where the network positioning procedure comprises determining a bearing from the vehicle to the wireless device or vice versa, based on a positioning signal transmitted over the direct radio link between the vehicle and the wireless device.

20-23. (canceled)

24. The method of claim 1, wherein the network positioning procedure comprises transmission of any of a sounding reference signal, SRS, a random access signal transmitted over a physical random access channel, PRACH, and/or a demodulation reference signal, DMRS of a third generation partnership, 3GPP, defined operator network.

25-26. (canceled)

27. The method of claim 1, wherein the network positioning procedure comprises positioning the vehicle with respect to a coordinate system prior to triggering the network positioning procedure involving the operator network.

28. (canceled)

29. The method of claim 1, wherein determining a position of the wireless device based on one or more measurements comprises determining the position at least partly based on any of: time of flight of the positioning signal, angle of arrival of the positioning signal, angle of departure of the positioning signals, and a received signal power of the positioning signal.

30. The method of claim 1, wherein determining the position of the wireless device based on the one or more measurements of the positioning signals comprises aligning the network positioning procedure with a movement strategy of the vehicle.

31. A vehicle arranged to partake in positioning a wireless device in a wireless communication system, wherein the wireless device is arranged to be connected to a respective operator network, wherein the vehicle is arranged to:
receive a request from a network entity to approach the wireless device,
associate itself with the operator network of the wireless device, and to
partake in a network positioning procedure involving the wireless device and the operator network, where the positioning procedure is based on communication of a positioning signal between the vehicle and the wireless device, and on communication of respective positioning signals between one or more fixed access points of the operator network and the wireless device.

32-40. (canceled)

41. A network node arranged to perform a network positioning procedure in a wireless communication system for positioning a wireless device connected to a respective operator network, assisted in part by a vehicle, wherein the network node is arranged to
receive a request for the vehicle to approach the wireless device,
associate the vehicle with the operator network of the wireless device,
trigger a network positioning procedure involving the wireless device and the operator network, where the positioning procedure is based on communication of a positioning signal between the vehicle and the wireless device, and on communication of respective positioning signals between one or more fixed access points of the operator network and the wireless device, and
determine a position of the wireless device based on measured time of flight of the positioning signals.

42-58. (canceled)
